(19) United States
(12) Patent Application Publication
(10) Pub. No.: US 2017/0147345 A1
(43) Pub. Date: May 25, 2017

(54) MULTIPLE OPERATION INTERFACE TO SHARED COPROCESSOR

(71) Applicant: KNUEDGE, INC., San Diego, CA (US)

(72) Inventor: William Christensen Clevenger, San Diego, CA (US)

(73) Assignee: KNUEDGE, INC., San Diego, CA (US)

(21) Appl. No.: 14/946,054

(22) Filed: Nov. 19, 2015

(51) Int. Cl. G06F 9/30

(52) U.S. Cl. CPC G06F 9/30079; G06F 9/30007

(57) ABSTRACT

In a multi-processor architecture, a plurality of processors share a coprocessor for certain instructions. Each processor may supply the coprocessor with a number of instructions and operands for those instructions. Other operations may be performed while waiting for the results. When the results are needed, the processor may be configured to force synchronization by suspending operations until the results are received. While waiting for the results, the processor enters a low-power state, waking up automatically when the last result waited upon is received.

### BACKGROUND

Multi-processor computer architectures capable of parallel computing operations were originally developed for supercomputers. Today, with modern microprocessors containing multiple processor “cores,” the principles of parallel computing have become relevant to both on-chip and distributed computing environment. Typically the cores within a microprocessor are structurally identical.

The capabilities of conventional microprocessors are sometimes supplemented to support specialized instructions by adding coprocessors. For example, the Intel 8086 supported an 8087 floating point coprocessor. Later Intel processors (e.g., 80286, 80386) also supported matching coprocessors (e.g., 80287, 80387 respectively).

As a more contemporary example, ARM processor designs have included an interface that allows adding a coprocessor to provide specialized processing capabilities to an ARM CPU (Central Processing Unit). Other coprocessors are available from third parties, and ARM licensees are allowed to add such custom coprocessors to an ARM CPU.

The known methods of interfacing between a processor and coprocessor have a number of characteristics in common. Among other common characteristics, they operate based on a microprocessor issuing a single instruction at a time to a coprocessor.

Modern microprocessor cores typically use a “pipelined.” This means that execution of an individual instruction is broken up into a number of stages. When one instruction progresses from one stage to the next, the next instruction can begin executing the previous stage. As an extremely simple example, three stages could be used: the first stage fetches the operand(s) for an instruction, the second carries out a specified operation on that operand (or those operands) and the third stage writes the result to a specified destination.

Pipelining interacts poorly with an instruction-by-instruction interface between the processor core and coprocessor. In particular, issuing a single instruction to the coprocessor, then synchronizing between the processor core and the coprocessor impedes use of the core's instruction pipeline.

There is, therefore, a need for an interface between a processor core and a coprocessor that allows synchronization at need, but also works well with pipelining to minimize synchronization and allow the coprocessor to execute a number of instructions in a pipelined fashion.

### BRIEF DESCRIPTION OF DRAWINGS

For a more complete understanding of the present disclosure, reference is now made to the following description taken in conjunction with the accompanying drawings.

FIG. 1 is a block diagram conceptually illustrating an example of a network-on-a-chip architecture providing a shared coprocessor supporting multiple processor cores.

FIG. 2 is a block diagram conceptually illustrating example components of a processing element of the architecture in FIG. 1.

FIG. 3 illustrates an example of instruction execution by a processor core of a processing element in FIG. 2.

FIG. 4 illustrates an example of pipeline stages of a processor core of a processing element in FIG. 2.

FIG. 5 illustrates a high-level example of a process flow for synchronization of a processing element with the shared coprocessor

FIG. 6 illustrates a more detailed example of a process flow for synchronization of a processing element with the shared coprocessor.

FIG. 7 illustrates an example of pipeline iterations of a processing element's core in FIG. 2 in relation to tasking functions to the coprocessor.

FIGS. 8A and 8B illustrate examples of pipeline stages of the processor core of a processing element in FIG. 2, based on the pipeline iterations in FIG. 7A.

FIG. 9 illustrates an example of how a core of a processing element from FIG. 2 may determine when the tasks assigned to the coprocessor have been completed and the results returned.

FIG. 10 is a block diagram conceptually illustrating example components of the shared coprocessor in FIG. 1.

FIG. 11 illustrates an example of instruction execution by a processor core of the coprocessor in FIG. 2.

FIG. 12 is an example overview illustrating how several of the components of the chip interact to synchronize a processing element with the coprocessor.

FIG. 13 is a block diagram conceptually illustrating another example of the network-on-a-chip architecture providing the shared coprocessor supporting multiple processor cores.

### DETAILED DESCRIPTION

In parallel processing systems that may be scaled to include hundreds (or more) of processor cores, what is needed is a method for software running on one processing element to communicate data directly to software running on another processing element, while continuing to follow established programming models, so that (for example) in a typical programming language, the data transmission appears to take place as a simple assignment.

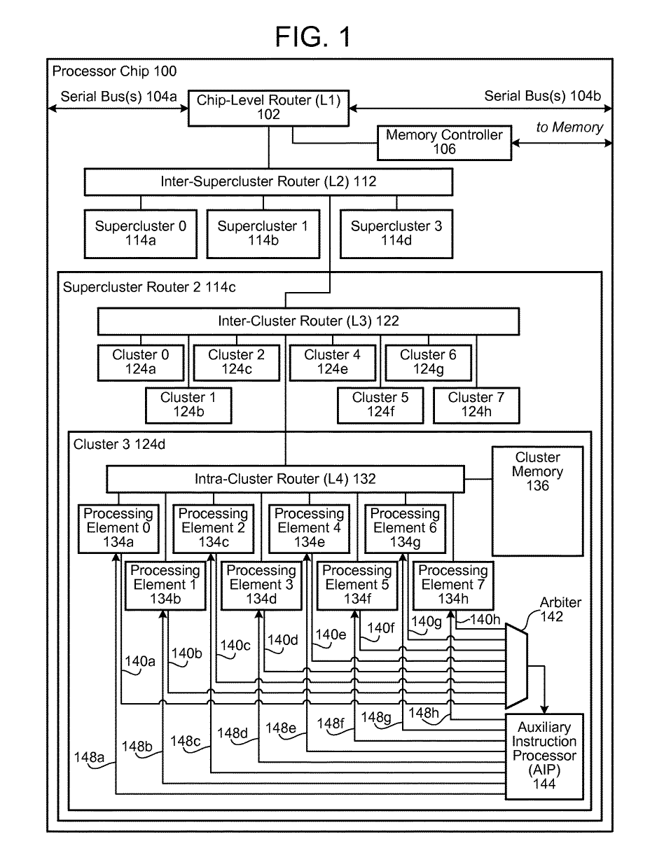

FIG. 1 illustrates a multiple core processing system based on a system-on-a-chip architecture. The processor chip 100 has an architecture structured as a nested hierarchy, with clusters 124 of processing elements 134 at its base. The processing elements 134a to 134h of each cluster share a auxiliary instruction processor (AIP) 144 that provides specialized coprocessor functionality. Each processing element 134a to 134h may issue a number of instructions to the coprocessor 144, and then optionally continue to execute other instructions that do not rely on the results from the coprocessor 144.

When results are needed from the AIP coprocessor 144, the processing element 134 may be configured by in either hardware or software to execute a forced synchronization. In response to this forced synchronization instruction, the processing element 134 ceases executing instructions and is placed in a low power state (e.g., declocked) until the results from the coprocessor instructions are ready. When the results from the coprocessor are ready, the processing element 134 resumes execution of instructions, such as executing instructions that use the values from the AIP coprocessor. If the results are ready when the processor executes the synchronization instruction, the processor simply continues execution without going into the low power state.

The interface between each processing element 134a-138b in a cluster 124 and the AIP 144 may be direct, such as an individualized input/output buses for each processing element (e.g., 140a-140h and 148a-148h), may use a shared bus, or may be via a network-like connection used to communicate between component hierarchies of the chip 100 (e.g., packet-based communications). In the latter case, operations for the AIP 144 may be encoded into a simple network packet format containing multiple operands, along with data to specify the operation(s) for the AIP 144 to carry out on those operands.

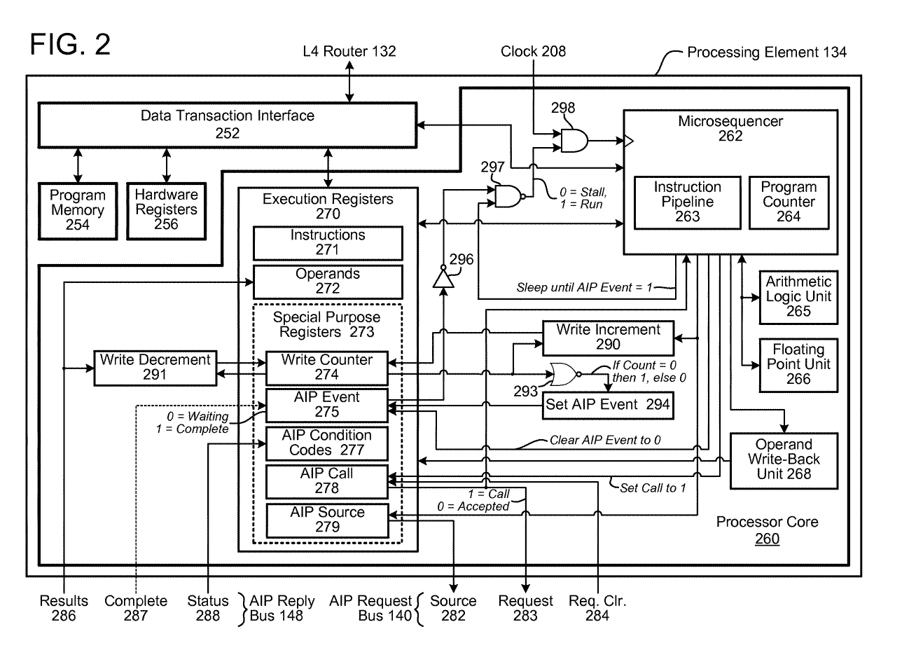

The illustrated example of a network-on-a-chip 100 may be composed of a large number of processing elements 134 (e.g., 256 processing elements), connected together on the chip via a switched or routed fabric similar to what is typically seen in a computer network. FIG. 2 is a block diagram conceptually illustrating example components of a processing element 134 of the chip 100 in FIG. 1.

Each processing element 134 may have direct access to some (or all) of the operand registers 272 of the other processing elements, such that each processing element 134 may read and write data directly into operand registers 272 used by instructions executed by the other processing element, thus allowing the processor core 260 of one processing element to directly manipulate the operands used by another processor core for opcode execution.

An “opcode” instruction is a machine language instruction that specifies an operation to be performed by the executing processor core 260. Besides the opcode itself, the instruction may specify the data to be processed in the form of identifiers of operands. An identifier of a register from which an operand is to be retrieved may be directly encoded as a fixed location associated with an instruction as defined in the instruction set, or may be a variable address location specified together with the instruction.

Each operand register 272 may be assigned a global memory address comprising an identifier of its associated processing element 134 and an identifier of the individual operand register 272. The originating processing element 134 of the read/write transaction does not need to take special actions or use a special protocol to read/write to another processing element's operand register, but rather may access another processing element's registers as it would any other memory location that is external to the originating processing element. Likewise, the processing core 260 of a processing element 134 that contains a register that is being read by or written to by another processing element does not need to take any action during the transaction between the operand register and the other processing element.

Conventional processing elements commonly include two types of registers: those that are both internally and externally accessible, and those that are only internally accessible. The hardware registers 256 in FIG. 2 is an example of conventional registers that are accessible both inside and outside the processing element 134. Such hardware register 256 may include, for example, configuration registers used when initially “booting” the processing element, input/output registers, and various status registers. Each of these hardware registers are globally mapped, and are accessed by the processor core associated with the hardware registers by executing load or store instructions.

The internally accessible execution registers in conventional processing elements include instruction registers and operand registers, which are internal to the processor core itself. These registers are ordinarily for the exclusive use of the core for the execution of operations, with the instruction registers storing the instructions currently being executed, and the operand registers storing data fetched from hardware registers 256, results, and data fetched from other memory as needed for the currently executed instructions. These internally accessible registers are directly connected to components of the instruction execution pipeline (e.g., an instruction decode component, an operand fetch component, an instruction execution component, etc.), such that ordinarily there is no reason to assign them global addresses. Moreover, since these registers are used exclusively by the processor core, they ordinarily are single “ported,” since data may be read or written to them, but not both (read and written) at the same time.

In comparison, the execution registers 270 of the processor core 260 in FIG. 2 are each dual-ported, with one port directly connected to the core's micro-sequencer 262, and the other port connected to a data transaction interface 252 of the processing element 134, via which the operand registers 272 can be accessed using global addressing. As dual-ported registers, data may be written to a register and read from a register at a same time (e.g., within a same clock cycle).

Communication between component on the processor chip 100 may be performed using packets, with each data transaction interface 252 connected to one or more bus networks, where each bus network comprises at least one data line. Each packet may include a target register's address (i.e., the address of the recipient) and a data payload. The address may be a global hierarchical address, such as identifying a multicore chip 100 among a plurality of interconnected multicore chips, a supercluster 114 of core clusters 124 on the chip, a core cluster 124 containing the target processing element 134, and a unique identifier of the individual operand register 272 within the target processing element 134.

For example, referring to FIG. 1, each chip 100 includes four superclusters 114a-114d, each supercluster 114 comprises eight clusters 124a-124h, and each cluster 124 comprises eight processing elements 134a-134h and an AIP 144. If each processing element 134 includes two-hundred-fifty six operand registers 272, then within the chip 100, each of the operand registers may be individually addressed with a sixteen bit address: two bits to identify the supercluster, three bits to identify the cluster, three bits to identify the processing element, and eight bits to identify the register.

The global address may include additional bits, such as bits to identify the processor chip 100, so that processing elements 134 and other components may directly access the registers of processing elements 134 across chips. The global addresses may also accommodate the physical and/or virtual addresses of a main memory accessible by all of the processing elements 134 of a chip 100, tiered memory locally shared by the processing elements 134 (e.g., cluster memory 136), etc. Whereas components external to a processing element 134 address the operand registers 272 of another processing element using global addressing, the processor core 260 containing the operand registers 272 may instead uses the register's individual identifier (e.g., eight bits identifying the two-hundred-fifty-six registers).

Other addressing schemes may also be used, and different addressing hierarchies may be used. Whereas a processor core 260 may directly access its own execution registers 270 using address lines and data lines, communications between processing elements through the data transaction interfaces 252 may be via bus-based or packet-based networks. The bus-based networks may comprise address lines and data lines, conveying addresses via the address lines and data via the data lines. In comparison, the packet-based network comprise a single serial data-line, or plural data lines, conveying addresses in packet headers and data in packet bodies via the data line(s).

The source of a packet is not limited only to a processor core 260 manipulating the operand registers 272 associated with another processor core 260, but may be any operational element, such as a memory controller 106, a Direct Memory Access (DMA) component, an external host processor connected to the chip 100, a field programmable gate array, or any other element communicably connected to a processor chip 100 that is able to communicate in the packet format.

In addition to any operational element being able to write directly to an operand register 272 of a processing element 134, each operational element may also read directly from an operand register 272 of a processing element 134, sending a read transaction packet indicating the global address of the target register to be read, and the global address of the destination address to which the reply including the target register's contents is to be copied.

A data transaction interface 252 associated with each processing element may execute such read, write, and reply operations without necessitating action by the processor core 260 associated with an accessed register. Thus, if the destination address for a read transaction is an operand register 272 of the processing element 134 initiating the transaction, the reply may be placed in the destination register without further action by the processor core 260 initiating the read request. Three-way read transactions may also be undertaken, with a first processing element 134x initiating a read transaction of a register located in a second processing element 134y, with the destination address for the reply being a register located in a third processing element 134z.

Memory within a system including the processor chip 100 may also be hierarchical. Each processing element 134 may have a local program memory 254 containing instructions that will be fetched by the micro-sequencer 262 and loaded into the instruction registers 271 for execution in accordance with a program counter 264. Processing elements 134 within a cluster 124 may also share a cluster memory 136, such as a shared memory serving a cluster 124 including eight processor cores 134a-134h. While a processor core 260 may experience no latency (or a latency of one-or-two cycles of the clock controlling timing of the instruction pipeline 263) when accessing its own operand registers 272, accessing global addresses external to a processing element 134 may experience a larger latency due to (among other things) the physical distance between the addressed component and the processing element 134. As a result of this additional latency, the time needed for a processor core to access an external main memory, a shared cluster memory 136, and the registers of other processing elements may be greater than the time needed for a core 260 to access its own execution registers 270.

Data transactions external to a processing element 134 may be implemented with a packet-based protocol carried over a router-based or switch-based on-chip network. The chip 100 in FIG. 1 illustrates a router-based example. Each tier in the architecture hierarchy may include a router. For example, in the top tier, a chip-level router (L1) 102 routes packets between chips via one or more high-speed serial busses 104a, 104b, routes packets to-and-from a memory controller 106 that manages primary general-purpose memory for the chip, and routes packets to-and-from lower tier routers.

The superclusters 114a-114d may be interconnected via an inter-supercluster router (L2) 112 which routes transactions between superclusters and between a supercluster and the chip-level router (L1) 102. Each supercluster 114 may include an inter-cluster router (L3) 122 which routes transactions between each cluster 124 in the supercluster 114, and between a cluster 124 and the inter-supercluster router (L2) 112. Each cluster 124 may include an intra-cluster router (L4) 132 which routes transactions between each processing element 134 in the cluster 124, and between a processing element 134 and the inter-cluster router (L3) 122. The level 4 (L4) intra-cluster router 132 may also direct packets between processing elements 134 of the cluster and a cluster memory 136 (which itself may include a data transaction interface). Tiers may also include cross-connects (not illustrated) to route packets between elements in a same tier in the hierarchy.

A processor core 260 may directly access its own operand registers 272 without use of a global address. Communications between the AIP and each processing element 134 in a cluster 124 may be bus-based or packet-based. As illustrated in FIGS. 1 and 2, each processing element 134a-134h is connected to an AIP request bus 140a-140h that is used by a processing element 134 to transfer data to the AIP 144 via an arbiter 142. Each processing element 134a-134h is also connected to an AIP reply bus 148a-148h via which the AIP loads function results into the execution registers 270 of the originating processor core 260.

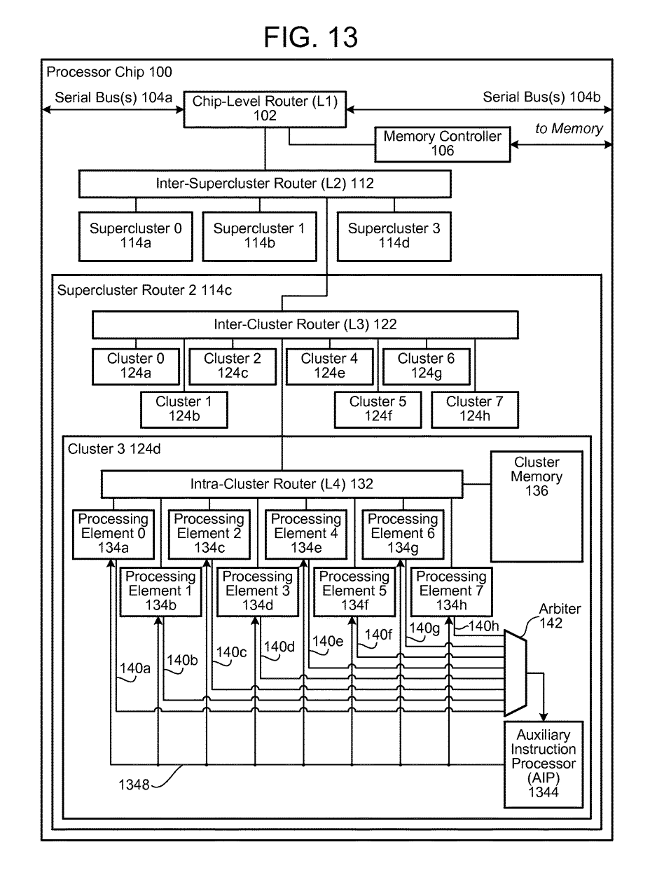

As illustrated, data transactions between the arbiter 142, AIP 144, and each processor core 260 are direct transactions, with the arbiter 144 directly transferring data queued in AIP source registers 278 by a processor core 260 to the AIP 144. Likewise, the AIP 144 writes back results of called AIP functions directly into the originating core's operand registers 272. As an alternative structure (which will be described below in connection with FIG. 13), a shared AIP result bus may be used to connect the AIP 144 to all of the processing elements 134 within a cluster.

Instead of direct AIP-to-execution register bus connections, AIP bus transactions may be conducted via the data transaction interface 252 of each processing element 134. Such connections may utilize data and address busses, or may be conducted using packets (adding a data transaction interface to the AIP 144 and/or arbiter 142). Packet-based AIP transactions may conducted via a dedicated connection or connections to each processing element's data transaction interface 252, or the intra-cluster L4 router 132.

Memory of different tiers may be physically different types of memory. Operand registers 272 may be a faster type of memory in a computing system, whereas as external general-purpose memory typically may have a higher latency. To improve the speed with which transactions are performed, operand instructions may be pre-fetched from slower memory (e.g., cluster memory 136) and stored in a faster/closer program memory (e.g., program memory 254 in FIG. 2) prior to the processor core 260 needing the operand instruction.

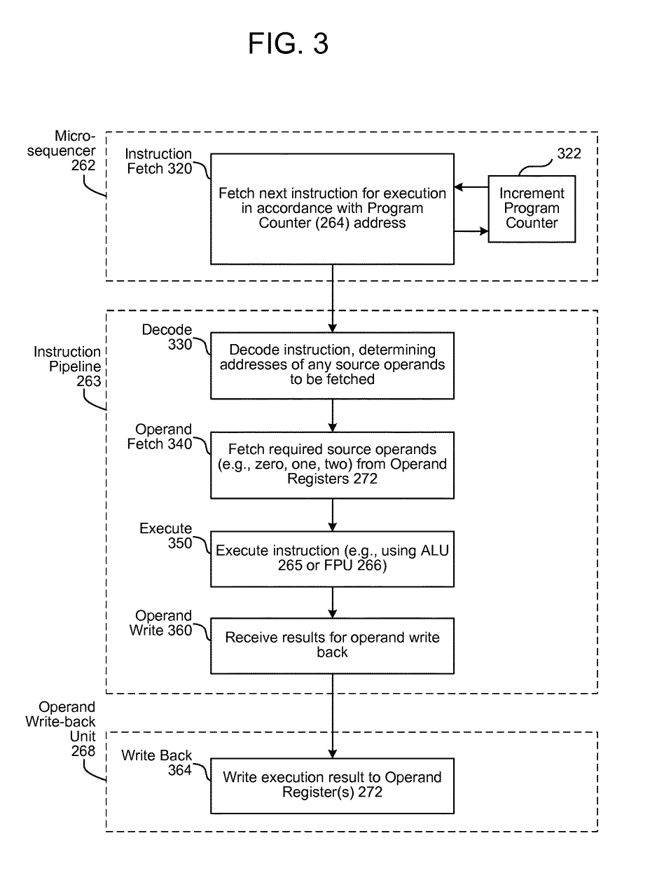

Referring to FIGS. 2 and 3, a micro-sequencer 262 of the processor core 260 may fetch (320) a stream of instructions for execution by the instruction pipeline 263 in accordance with an address specified by a program counter 264 used to generate a memory address. The memory address may correspond to an address in the processing element's own program memory 254, or some other location in the memory hierarchy, such as issuing one or more read requests to either cluster memory 136 or main memory (not illustrated, but connected to memory controller 106 in FIG. 1). The micro-sequencer 262 controls the timing of the instruction pipeline 263 in accordance with transitions of a clock signal (e.g., clock 208). The timing of the clock 208 within each cluster 124 may be independent of the clocks in other clusters, but ordinarily, the processing elements 134 and AIP 144 within a cluster 124 are within a same clock “domain” (i.e., share a same clock signal).

The program counter 264 may, for example, present the address of the next instruction in the program memory 254 to enter the instruction pipeline 263 for execution, with the instruction fetched 320 by the micro-sequencer 262 in accordance with the presented address. If utilizing local memory, the address provided by the program counter 264 may be a local address identifying the specific location in program memory 254, rather than a global address. After the instruction is read on the next clock cycle of the clock 208, the program counter may increment 322. A stage of the instruction pipeline 263 may decode (330) the next instruction to be executed. The same logic circuit that implements the decode stage may also present the address(es) of the operand registers 272 of any source operands to be fetched.

An opcode instruction may require zero, one, or more source operands. The source operands may be fetched (340) from the operand registers 272 by an operand fetch stage of the instruction pipeline 263. For opcode instructions to be executed within the processor core 260 itself, the decoded instruction and fetched opcodes may be presented to an arithmetic logic unit (ALU) 265 of the processor core 260 for execution (350) on the next clock cycle. The arithmetic logic unit (ALU) 265 may be configured to execute arithmetic and logic operations in accordance with the decoded instruction using the source operands. The processor core 260 may also include additional component for execution of operations, such as a floating point unit 266. However, as will be further discussed below, specialized and complex arithmetic instructions and their associated source operands may be sent by the execution stage 350 of the instruction pipeline 263 to the AIP 144 for execution.

If the instruction execution stage 350 of the instruction pipeline 263 uses the ALU 265 to execute the decoded instruction, execution by the ALU 265 may require a single cycle of the system clock 208, with extended instructions requiring two or more. Instructions may be dispatched to the FPU 266 in a single clock cycle, although several cycles may be required for execution. If an instruction executed within the processor core 260 produces one or more operands as a result, an operand write (360) of the results will occur. The operand write 360 specifies an address of a register in the operand registers 272 where the result is to be written.

After execution, the result may be received by an operand write stage 360 of the instruction pipeline 263 may be provided the result to an operand write-back unit 268 of the processor core 260, which performs the write-back (364), storing the results data in the operand register(s) 272. Depending upon the size of the resulting operand and the size of the registers, extended operands that are longer than a single register may require more than one cycle to write.

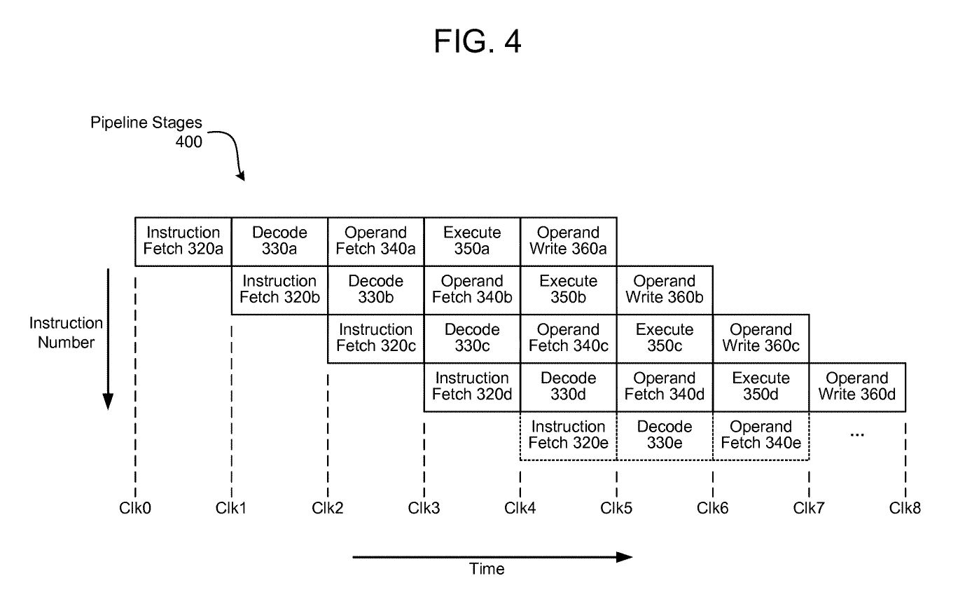

FIG. 4 illustrates an example execution of pipeline stages 400 in accordance with processes in FIG. 3. As noted in the discussion of FIG. 3, each stage of the pipeline flow may take as little as one cycle of the clock used to control timing. Although the illustrated pipeline flow is scalar, a processor core 260 may implement superscalar parallelism, such as a parallel pipeline where two instructions are fetched and processed on each clock cycle.

An event flag may also be associated with an increment or decrement counter. A processing element's counters (e.g., write increment counter 290 and write decrement counter 191 illustrated) may increment or decrement bits in special purpose registers 273 (e.g., write counter register 274) to track certain events and trigger actions (e.g., trigger processor core interrupts, wake from a sleep state, etc.). For example, when a processor core 260 is waiting for the results of five AIP function calls to be written to operand registers 272, a write counter 274 may be set as a “semaphore” to track of how many times the writing of data to the operand registers 272 occurs, where the writing of the fifth result by the AIP triggers an event (e.g., setting AIP event flag 275).

In computer science, a “semaphore” is a variable or abstract data type that is used for controlling access, by multiple processes, to a common resource in a concurrent system such as a multiprogramming operating system. Here, the common resource is the AIP 144, and the write counter 274 serves as a semaphore. When the specified count is reached, the semaphore triggers an event, such as altering a state of the processor core 260. A processor core 260 may, for example, set the counter 274 and enter a reduced-power sleep state, waiting until the counter 274 reaches a designated value before resuming normal-power operations.

If a cluster includes multiple shared AIPs 144, multiple semaphores may be used per processing element, with each semaphore corresponding to a shared resource. In the alternative, if a cluster includes multiple shared AIPs 144, as single semaphore may be used per processing element, where the semaphore does not trigger an event until results are received back from all of the shared resources. A processing element may support both semaphores paired to resources and a semaphore associated with multiple resources, with the type of semaphore used being controlled by software in accordance with the type of concurrent operations being performed.

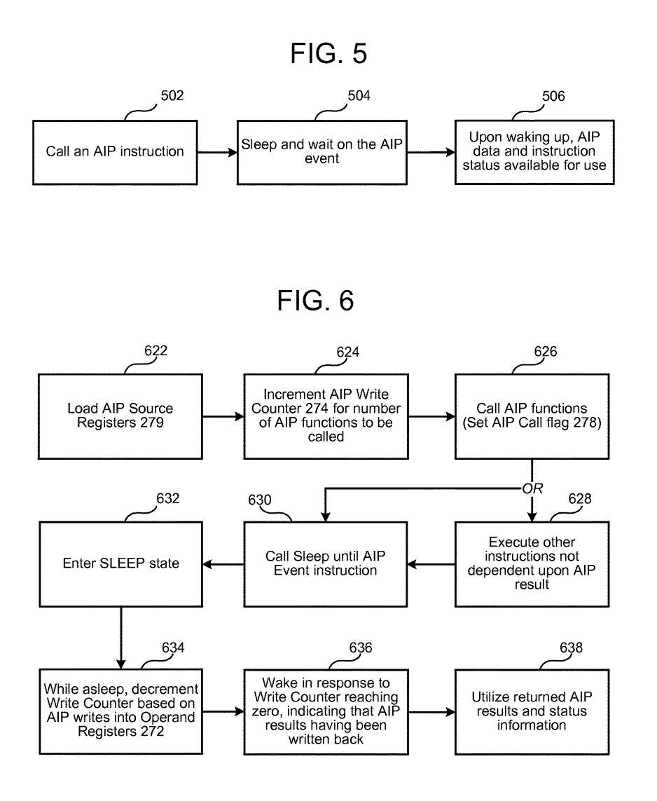

FIG. 5 illustrates a high-level example of a process flow for synchronization of a processing element with the shared AIP coprocessor 144. A processing element 134 calls (502) an AIP instruction, tasking the AIP to perform the function. The processing element 134 may thereafter enter a sleep state (504) to wait for the AIP 144 to return the results, with the results triggering an event within the processing element 134. Upon waking up (506) in response to the trigging event, the AIP data is available to the processing element's instruction pipeline 263 for use as operands in subsequent instructions. The AIP 144 may also return status information related to execution of the instruction or instructions, such as if a divide-by-zero error occurs.

The AIP 144 is available for use by all processing elements 134a-134h within the same cluster 124. The AIP 144 may be structured to perform a small set of operations, such as mathematically complex operations that are sometimes necessary, but which are expected to be called less frequently than simpler mathematical operations.

For example, the AIP 144 may include a plurality of specialized arithmetic processing cores, such as single-precision floating point processing cores to calculate sine and cosine functions, to execute a natural logarithm functions, to execute exponential functions, to execute square root functions, and to execute reciprocal calculation functions. The AIP 144 may also include specialized data processing cores, such as cores configured to execute data encryption and decryption functions, and to data execute compression and decompression functions. The AIP 144 may also include one or more specialized arithmetic processing cores to calculate fixed point functions such as a 2-operand arctangent function. Another example of a specialized core of the AIP 144 is an integer processing core to execute unsigned division and/or unsigned modulo functions.

Ordinarily, such calculations could be performed by the processing element 134 itself by breaking each function into a series of operations to be performed over multiple cycles. However, such operations effectively stall operations of the processing element 134 while it completes the complex operation. Another alternative is to provide each processing element 134 with its own circuitry to perform the complex operations in fewer cycles. However, the additional physical surface area on the semiconductor die needed to include the additional circuitry in each processing element 134 can be cost and space prohibitive.

By sharing the circuitry to perform such complex functions among multiple processing elements 134, the specialized cores within the AIP 144 may be optimized for the specific instructions that they each execute, balancing the surface area of the die needed to construct such circuits against efficiency gains to be had by providing the processing elements 134 with such additional resources. Moreover, the processing elements may task an AIP 144 to perform a complex function, and then execute additional instructions until such time as an instruction executed by the processing element requires a result of the AIP 144 as an operand.

Because the AIP 144 is a shared resource, even moderate use and contention for AIP functions can result in significant delays in AIP operations returning their results. As a result, in every case where an AIP operation requires multiple cycles to complete, the AIP execution is decoupled from the processing element 134 pipeline. In some circumstances, the AIP 144 may be able to execute a specialized function fast enough to avoid stalling a processing element's instruction pipeline 263 when it needs a result from the AIP as an operand for a subsequent instruction. In other circumstances, when the processing element delegates an instruction to the AIP 144 and the result is not ready before an instruction requiring the result as a source operand (e.g., before the subsequent instruction reaches the operand fetch stage 340), it is necessary to use a per-processing element waiting-on-AIP event to synchronize the processing element 134 with the AIP 144 returning the result. Failure to synchronize with the AIP write-back could result in the data and status being missed or overwritten.

In such circumstances, the processing element 134 is instructed to sleep (504) and wait on the result. For example, when a software compiler compiles source code for the processor chip 100 into machine instructions and one-or-more AIP-related functions are called, the compiler may insert a wait-on-AIP instruction immediately prior to a subsequent instruction that requires a result from the AIP function. When the wait-on-AIP instruction is loaded into the execute stage 350 of a processing element's instruction pipeline, circuitry determines whether or not the AIP has loaded the results or not. If the results have been loaded, the instruction pipeline 134 proceeds to the next instruction. Otherwise, the processing element 134 sleeps and waits for the return of the results to trigger an event, at which time it resumes processing (506).

Depending on contention for the AIP, there may be many cycles between calling an AIP instruction (502) and the processing element entering a wait-on-AIP sleep state (504). Thus instructions may be interposed between these steps. The interposed instructions have no interdependency with the AIP instruction's result and will not read or overwrite the operand register(s) assigned to the AIP instruction as a result destination register or registers.

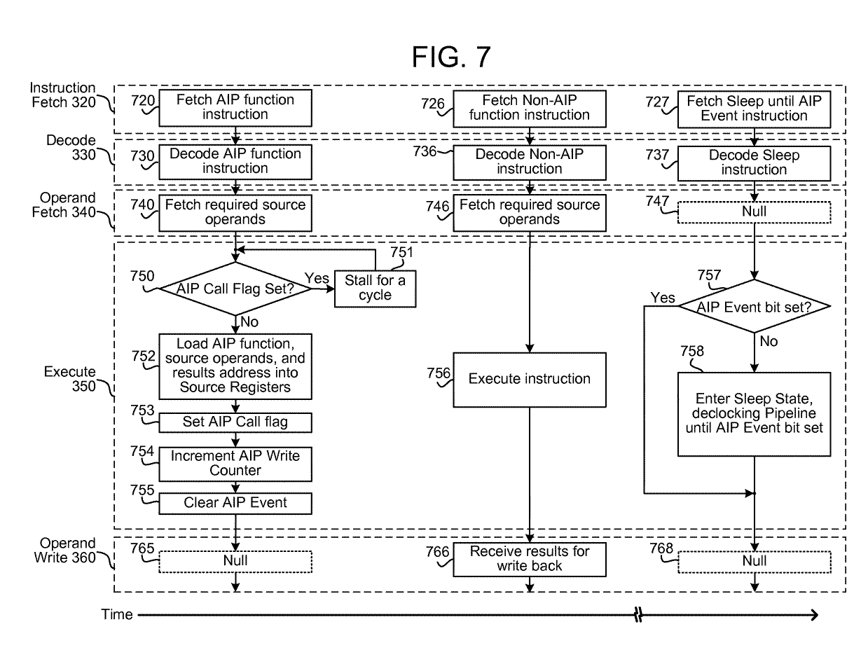

FIG. 6 illustrates a more detailed example of a process flow for synchronization of a processing element with the shared coprocessor. This process flow uses several special purpose registers 273 of the originating processing element's execution registers 270. When the instruction pipeline 263 of the processor core 260 needs to execute an function using the AIP, the instruction pipeline 263 loads (622) the instruction, any needed operands, and an address of the operand register(s) into which the result is to be written into a set of AIP source registers 279. The execution stage 350 of the instruction pipeline 263 may include circuitry to write this data into the AIP source registers 279 (e.g., a counter that serves as write pointer, incrementing the address with each write) or may be executed through the operand write-back unit 268, with the execution stage 350 sending the data to the write-back unit, which proceeds to load the data into the AIP source registers 279.

Each time an instruction is loaded into the AIP source registers 279, a write increment circuit 290 increments (624) a write counter register 274 of the special purpose registers 273. The value in the write counter register 274 keeps track of the number of AIP functions to be called.

The instruction pipeline 263 “calls” the AIP functions (626) by setting an AIP call register flag 278 in the special purpose registers 273. The setting of the AIP call register flag 278 signals the arbiter 142 (via a request bit 283 of the AIP request bus 140) that the source registers 279 of the processing element 134 contain data for processing by the AIP 144. If a subsequent instruction needs to write to the AIP source registers 279 before the AIP call flag 278 is cleared by the arbiter 142 the execute stage 350 may stall operation of the instruction pipeline until after the call flag 278 is cleared. A stall is a response to a temporary input/output (I/O) issue like register access availability, and is used to prevent the overwriting of data and/or losing data as it is moved around the chip 100. The microsequencer 262 and the rest of the processor core 260 remains active, but the instruction execution pipeline 263 does not advance until the problem clears. In comparison, “sleep” is a low power state where the microsequencer 262 is de-clocked (and may also be powered down), such that a “wake” restarts the pipeline. After the data is transferred from the AIP source registers 279 to the AIP 144, the arbiter 142 clears the AIP call flag 278 via a request clear bit 284 of the AIP request bus 140. Once the flag is cleared, the execute stage 350 resumes processing, and the instruction pipeline 263 continues execution.

The instruction pipeline 263 may continue to execute instructions (628) that are not dependent upon an AIP result. When an instruction requires an AIP result, an instruction to force synchronization will be executed (630), setting a sleep until AIP event signal that results in the microsequencer 262 entering a sleep state (632) due to being de-clocked if the AIP event flag 275 is not already set (i.e., true).

For example, referring to FIG. 2, a sleep until AIP event signal may be output by the execute stage 350 of the instruction pipeline 263 to a NAND gate 297. Although not illustrated, if the microsequencer 262 is also powered down when in a low power state (in addition to being de-clocked), the setting of the sleep until AIP event state may be latched so that the state is maintained after the microsequencer 262 is powered down. The other input of the NAND gate 297 receives a state NOT AIP event, which is the state of the AIP event flag 275 inverted by inverter 296. If the sleep until event flag is set (i.e., true) and the AIP event flag 275 is clear (i.e., false), then the output of the NAND gate 297 will be false, causing the AND gate 298 to de-clock the micro-sequencer. When the AIP event flag is set (i.e., true) indicating that AIP results are no longer being waited on, the output of the NAND gate 297 becomes true and the AND gate 298 resumes clocking the microsequencer 262.

Each time the result from an AIP function is written to the operand registers 272, such as via a results bus 286 of the AIP reply bus 148, a write decrement circuit 291 decrements (634) the write counter 274. Circuitry (e.g., NOR gate 293) monitoring the write counter 274 initiates an event when the write counter reaches zero, triggering a circuit 294 (e.g., a monostable multi-vibrator) to set the AIP event flag 275. The AIP event flag 275 being true (1) indicates that the results being waiting on have been returned and that the called AIP functions are complete. The AIP event flag 275 being false (0) indicates that AIP results are still being waited upon.

In the alternative, the AIP may send a completion signal (via complete bit 287 of the AIP reply bus 148) in response to the results of the last instruction it received from the processing element 134 having been executed and the results returned, with the completion signal setting the AIP event flag 275. The complete bit 287 operates as a mutex flag. In computer science, mutual exclusion or “mutex” refers to a requirement of ensuring that no two concurrent processes are in their critical section at the same time. It is a basic requirement in concurrency control. A “critical section” refers to a period when the process accesses a shared resource, such as in this case, results produced by the shared AIP 144.

However, since the AIP is handling requests from multiple processing elements 134, and the results may be returned out-of-order (discussed further below), having each processing element 134 keep track of whether it is waiting on AIP results may be less complex than having the AIP 144 keep track for each processing element. In particular, having the AIP track returns for each processing element does not necessarily result in a reduction of circuitry, since the returns to each processing element must be tracked individually.

For example, a write counter register for each processing element 134 could be included in the AIP 144. For each instruction received by the AIP 144 from a processing element 134, the write counter associated with the originating processing element may be incremented, and for every result written to that processing element, its write counter may be decremented. This essentially relocates each write increment circuit 290, write decrement circuit 291, write counter 274, count monitoring circuit 293, and AIP event-setting circuit 294 from each processing element 134 to the AIP 144.

However, if a processing element 134 were configured to automatically call (using flag 278) the AIP after a specified number of instructions were loaded into the source registers 279 (independent of how the instructions were compiled), this would require a duplication of circuitry. Automatic calling of the AIP based on the number of AIP instructions loaded could be used to adaptively perform load balancing, such as by monitoring the delays associated with transferring the data via the arbiter 142 and adjusting the specified number of loads before an automatic call for the processing elements within the cluster 124 accordingly. Also, by having the write counter 274 resident in the processing element 134, subsequent instructions may be executed by the instruction pipeline 263 to determine how many results remain to be returned. Knowing how many instructions remain to be returned could be used, for example, to make a branching decision.

Once the AIP event flag 275 is set, the clock signal 208 is restored, waking (636) the instruction pipeline 263, which may thereafter execute (638) instructions utilizing the AIP results. In addition to writing the AIP results into the operand registers 272, the AIP 144 may also return one or more AIP condition codes via a status bus 288 of the AIP reply bus 148, which are written into AIP condition code register(s) 277 of the special purpose registers 273. Examples of condition codes may include a divided-by-zero indication, and the sign (positive/negative) of a returned result.

Although signaling between the AIP 144 and the special purpose registers 273 may be performed via dedicated bus lines, such signaling may also be performed using packet transactions (e.g., via the data transaction interface 252). Such packet transactions may be used to write to the individual flags and registers.

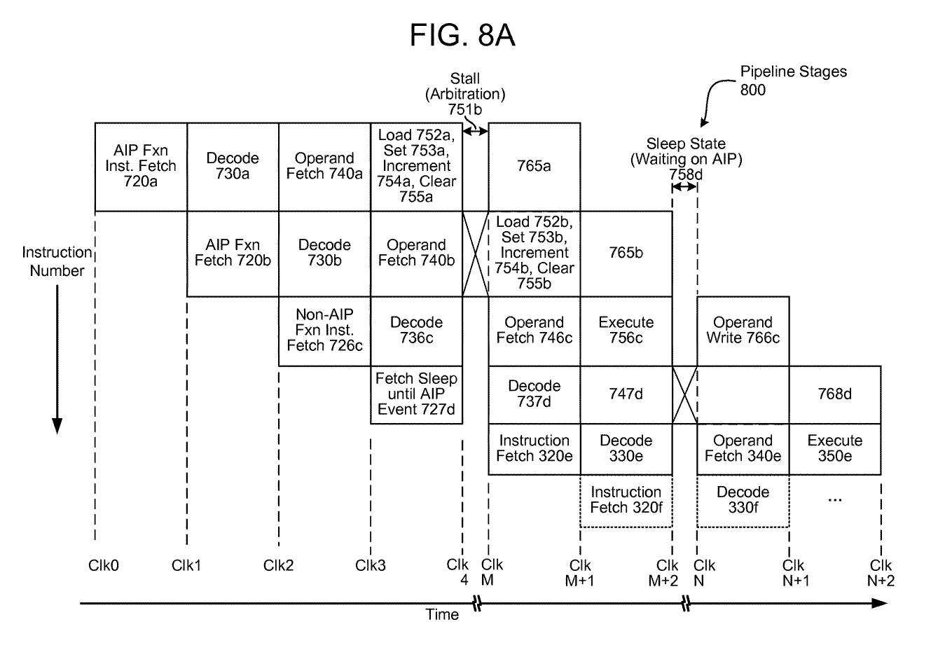

FIG. 7 illustrates an example of pipeline iterations of a processing element's core 260 in FIG. 2 in relation to tasking functions to the AIP coprocessor 144. The pipeline stages (320, 330, 340, 350, 360) are the same as those discussed in connection with FIGS. 3 and 4.

Referring to FIG. 7, the instruction fetch stage 320 fetches (720) an AIP function instruction. The decode stage 330 then decodes (730) the AIP function instruction. The operand fetch stage 340 then fetches (740) any required source operands. The execution stage 350 determines (750) whether the AIP call flag 278 is set. If it is set (750 “Yes”), the execution stage 350 stalls (751) for one clock cycle and then checks again. Once the AIP call flag 278 is clear (750 “No”), the execution stage 350 loads (752) the AIP function, the source operands, and a results address for operand registers 272 where the AIP results are to be written into the AIP source registers 279. This write may be performed by write circuitry, or may be delegated to the operand write-back unit 268, using addresses of AIP source registers 279 as specified by a write pointer/counter (not illustrated). The instruction written to the AIP source registers 279 may be a partially decoded or fully decoded instruction, reducing the complexity of the decode circuitry needed within the AIP 144.

The execution stage 350 sets (753) the AIP AIP call flag 278. The execution stage circuitry may explicitly increment (754) the write counter 274 (via write increment circuit 290), or the write increment circuit 290 may monitor writes to a range of addresses of the AIP source registers 279 and increment accordingly. The execution stage 350 also clears (755) the AIP event flag 275 (which may or may not already be clear). As the operand write in response to the AIP instruction will be performed by the AIP 144 rather than the processor core 260, nothing is done in the operand write stage 360 (marked as “null” 765).

Thereafter, the instruction fetch stage 320 fetches (726) a non-AIP function instruction, which the instruction decode stage 330 decodes (736). The operand fetch stage fetches (746) any needed operands, and the instruction execute stage 350 executes (756) the instruction. The operand write stage 360 receives (766) any results for write-back, to be written back by the operand write-back unit 268.

The compiler used to compile the instructions may insert a forced synchronization instruction before an instruction that will use an AIP result as a source operand. The forced-synchronization instruction is fetched (727) by the instruction fetch stage 320 as a sleep until AIP event instruction. This instruction is decoded (737) by the decode stage 330. Nothing may occur in the operand fetch stage (indicated by null 747), or the operand fetch stage may fetch the state of the AIP event flag 275.

The execute stage 350 may determine (757) whether there are still AIP requests pending based on whether an AIP event is indicated by the event flag 275. If there are results pending (757 “No”), the execute stage 350 may output a sleep until AIP event signal (to NAND gate 297), causing the instruction pipeline 263 to enter a sleep state 758 until the results are received (e.g., the write counter reaches zero). Otherwise (757 “Yes”), processing continues without entering the sleep state. As an alternative to explicitly checking (757) whether the AIP event bit is set, the execution stage may instead always output the sleep until AIP event signal in response to the forced synchronization instruction, since the sleep logic (gates 296, 297, and 298) will not enter the sleep state if the AP event flag 275 is already set. As there is no direct result from the forced synchronization instruction, nothing occurs in the operand write stage 360 (illustrated as null 768).

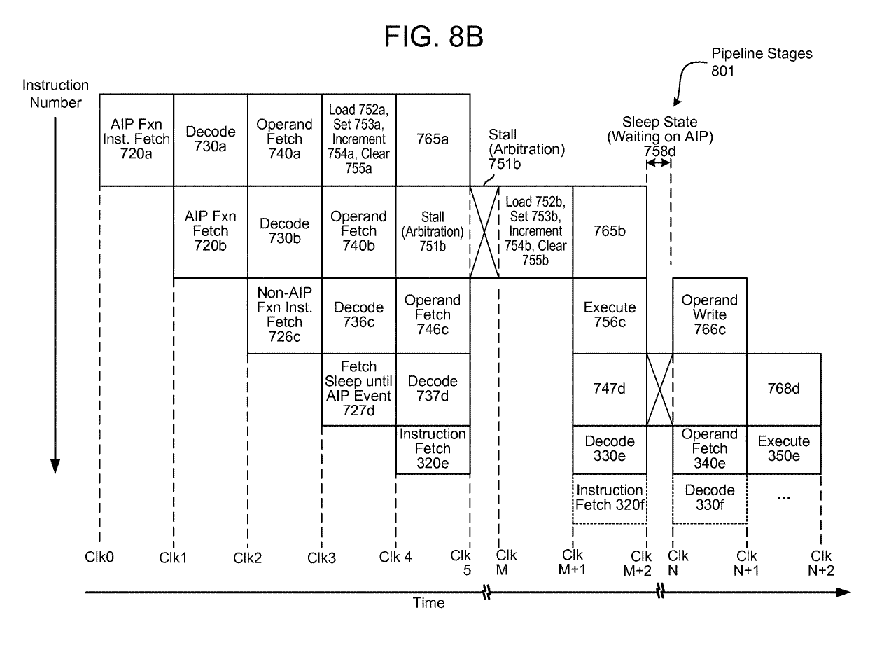

FIG. 8A illustrates an example of pipeline stages 800 of the processor core 260 of a processing element 134 in FIG. 2, based on the pipeline iterations in FIG. 7. Blank spaces between stages indicate that the pipeline flow is stalled (751) or that the micro-sequencer is asleep (758).

A first AIP function is fetched (720a), decoded 730a, operands are fetched 740, and the various AIP call operations are performed (752-755). After the first AIP function is fetches (720a), a second AIP function is fetched (720b). The pipeline flow continues (decode 730, operand fetch 740b) until the execute stage is reached, at which point the pipeline stalls (751b) until AIP call flag 278 is cleared. In the example in FIG. 8A, an execute stage stall stalls all stages of the pipeline. After the AIP call flag is cleared by the arbiter 142, pipeline processing resumes.

After the second AIP function is fetched (720b), a non-AIP function is fetched (726c) and processed (decode, etc.). After that, a forced synchronization instruction is fetched (727d), resulting in the pipeline entering a sleep state (758d) until the AIP event flag 275 is set. After the AIP event flag 275 is set, the pipeline is re-clocked and additional instructions are fetched (e.g., 320e, 320f). These subsequent instructions may be, for example, instructions that will use the AIP results as source operands.

FIG. 8B illustrates another example of pipeline stages 801 of the processor core 260 of a processing element 134 in FIG. 2, based on the pipeline iterations in FIG. 7. In this example, a stall (751b) stalls the execute stage, but not previous stages until the stall of the execution stage results in the process flow backing up. So, for example, the operand fetch (746c) for the next instruction overlaps the stall (751b), but then since the execution stage is not available yet to accept those operands, the that flow also stalls. As illustrated in FIGS. 8A and 8B, the overall timing is the same. However, if an operand fetch, for example, requires more than one clock cycle to execute, allowing the operand fetch stage 340 to perform the fetch while the execute stage is stalled may speed up performance by one clock cycle (since in FIG. 8A, operand fetch stage 746c requiring two cycles to fetch operands would create a similar back up of the process flow, stalling prior stages).

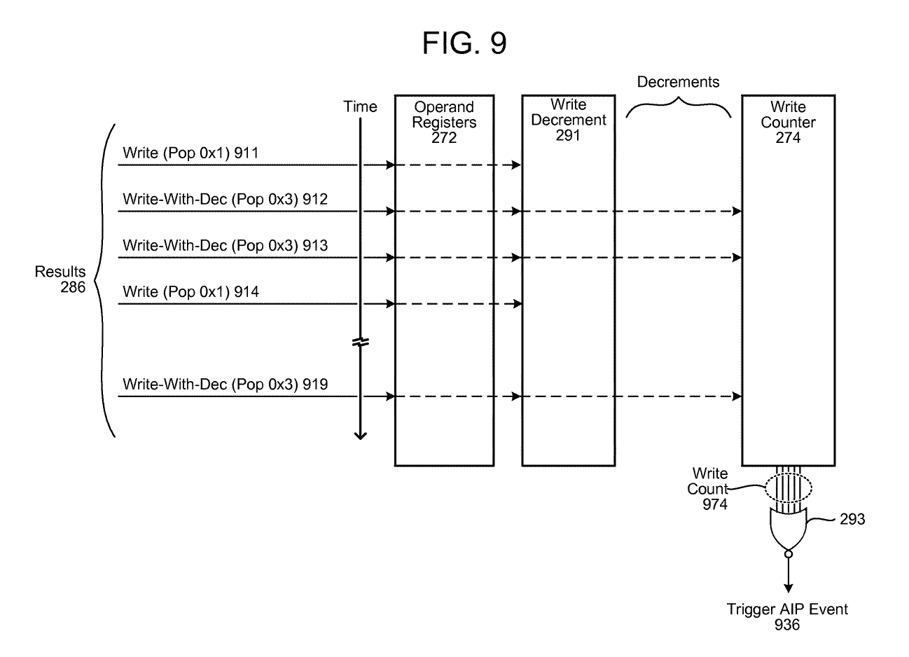

FIG. 9 illustrates an example of how a core of a processing element from FIG. 2 may determine when the tasks assigned to the coprocessor have been completed and the results returned. The AIP 144 may write back results into the operand registers 272 of an originating processing element 134 using write-with-decrement or just a plain write. Write-with-decrement causes the write decrement circuit 291 to decrement the write counter 274, whereas plain writes do not. This allows multiple writes-per-function, with only one of the writes triggering a decrement. The binary count (write count 974) in the write counter is read by an output circuit (e.g., NOR gate 293), and when the count reaches zero, the output circuit triggers an event 936 (e.g., transitioning from low to high).

In the example in FIG. 9, the results (e.g., via results bus 286) of three AIP functions are written back. The first result comprises a write without decrement 911, and a write with decrement 912. This result may be, for example, a long integer that requires two registers. The second result comprises a single write with decrement 913. The third result comprises a write-without-decrement 914 and a write-with-decrement 919. Using this approach, the number of writes that trigger a decrement correspond to the number of AIP functions called, and allows for the number of writes per instruction to vary as needed.

After an AIP request is queued by a processing element 134, the arbiter 142 may determines if the request is next in round robin order. If the request is not next in the order, the request may sit in the processing element's AIP source register queue 279 until the processing element 134 is selected in round-robin fashion. When the arbiter 142 transfers the request to the AIP 144, the arbiter 142 may add data (e.g., three bits) to each instruction to specify the originating processing element 134. However, if the addresses of the operand registers 272 of each processing element 134a to 134h are unique, then the return address itself may specify the originating processing element by itself.

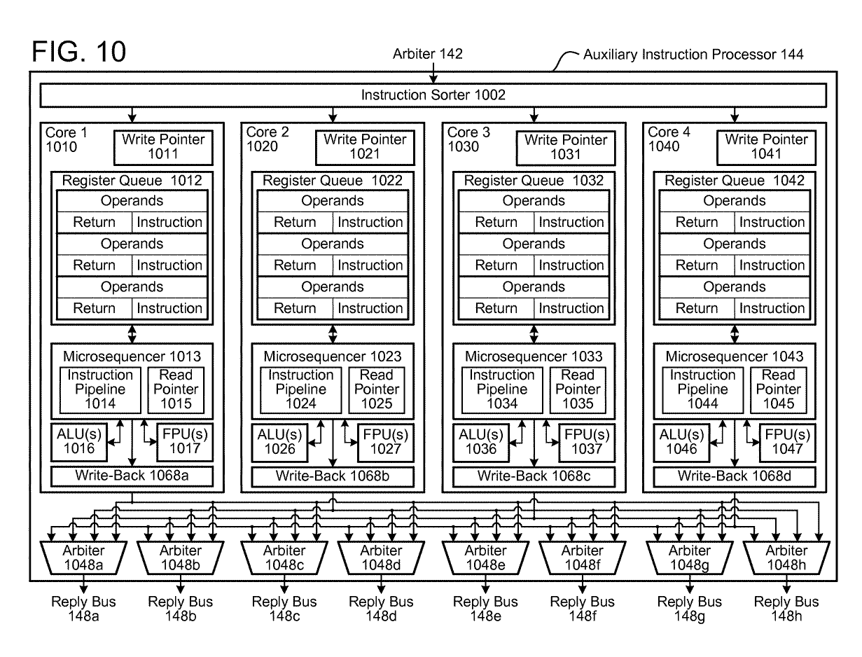

FIG. 10 is a block diagram conceptually illustrating example components of the shared AIP coprocessor 144 in FIG. 1. In this example, there are four cores (1010, 1020, 1030, 1040), but fewer or more cores may be included. Each of the cores is optimized to execute specialized mathematical functions at a hardware level, such as sines, cosines, logarithms, square roots, reciprocals, arctangents, unsigned division, and unsigned modulo functions. The components of the four cores are illustrated generically, but may be (and usually would be) have differences at a circuit level.

An instruction sorter 1002 receives AIP function instructions via the arbiter and loads them into the appropriate register queue 1012, 1022, 1032, 1041. In essence, the instruction sorter 1002 is a demultiplexer. The register queues may be circular queues, with a write pointer (1011, 1021, 1031, 1041) being used by the instruction sorter 1002 to determine where to store received data in the respective register queue. With each write to a respective queue, the corresponding write pointer is incremented, looping back to the beginning when reaching the last address. The micro-sequencer (1013, 1023, 1033, 1043) of each core reads from it respective register queue in accordance with a read pointer (1015, 1025, 1035, 1045). Logic circuits may be included to stall writes into a register queue if that register queue's write pointer catches up to its read pointer, preventing unprocessed data from being overwritten.

The instruction sorter 1002 selects which queue to write an instruction and its associated data into based directly on the instruction itself. For example, all sine and cosine function instructions will be loaded into register queue 1012, all logarithm function instructions will be load into register queue 1022, all modulo function instructions will be loaded into register queue 1032, etc.

Each core (1010, 1020, 1030, 1040) includes an instruction pipeline (1014, 1024, 1034, 1044), and depending upon the instructions to be executed, may include one or more ALUs (1016, 1026, 1036, 1046) and/or FPUs (1017, 1027, 1037, 1047). If the instructions provided by the processing elements 134 arrive already decoded, then the AIP's 134 instruction pipelines can forgo the decode stage, accelerating processing by one clock cycle. Also, since the decoded instruction and operands can be fetched accessed/directly from the corresponding register queue, the instruction and operand fetch stages can be combined into a single step fetch stage, accelerating processing by another clock cycle.

The execution stage of each pipeline (1014, 1024, 1034, 1044) will be different, and may take a different amount of time to complete an instruction. As a result, instructions entering a different AIP pipeline on a same clock cycle may leave reach the operand write 1160 stage at a different time. Also, depending upon the backlog in each register queue (1012, 1022, 1032, 1042), some instructions may be acted upon faster than others. An end result is that the order results are written back to an originating processing element 134 may be different than the order in which the originating processing element loaded the instructions. However, since the originating processing element 134 will sleep until all the results are received, the out-of-order execution has no negative impact and promotes instruction execution as fast as possible (under present AIP load conditions).

Each core of the AIP 144 includes an operand write-back unit (illustrated as 1068a to 1068d) which receives results from the operand write stage of its associated instruction pipeline, and works in conjunction with arbiters 1048a to 1048h which manage access to the reply busses 148a to 148h. Which reply bus should be used may be determined by the reply address(es), illustrated as a “return” entry in the register queues (1012, 1022, 1032, 1042). As noted above, if the return address of the operand registers 272 is not unique, the arbiter 142 may append a designation of the originating processing element 134 onto the reply address(es). The write back units 1068 then use this appended information (e.g., 3 bits) to determine which reply bus 148 to use.

Depending upon the speed of the cores (1010, 1020, 1030, 1040), one core could be writing to one originating processing element while another core is writing to another. A processing element calling instructions that will be handled by a “fast” core (by virtue of the number of cycles of its execution stage to complete an operation and/or the emptiness of its register queue) may receive its results before a processing element calling instruction to be handled by a busier or slower core.

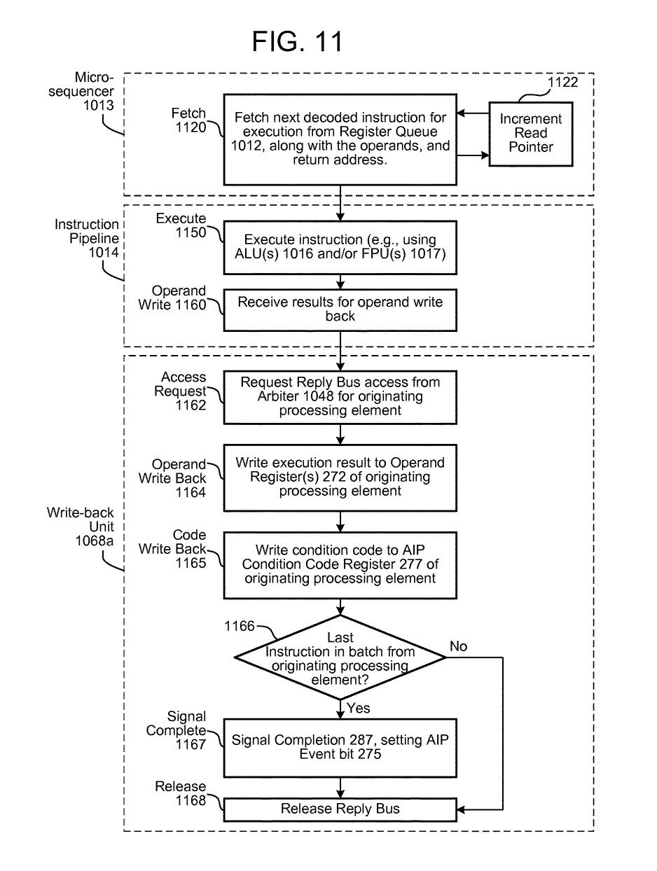

FIG. 11 illustrates an example of instruction execution by processor core 1010 of the coprocessor 144. Operational steps would be the same or similar for the other processor cores 1020, 1030, 1040.

In accordance with the read pointer 1011, the micro-sequencer 1013 fetches the next decoded (or partially decoded) instruction for execution from the register queue 1012, along with any associated operands, and the return address to which the reply is to be sent (including either an explicit or implicit identifier of the originating processing element 134. The micro-sequencer 1013 increments (1122) the read pointer 1011 as the data is fetched. If needed, a decode stage and operand fetch stage may be included in the instruction pipeline 1014, but as noted above, depending upon if the instruction is loaded into the register queue 1022 already decoded (by the processing element's decode stage 330) with the operands directly into the register queue 1032 within the core 1010, then such stages may be omitted to improve performance.

The execute stage 1150 of the instruction pipeline 1014 executes the fetched instruction, using the ALU(s) 1016 and/or FPU(s) 1017 (if included, and as needed, depending upon the instructions for which core 1 1010 is optimized. The results are received by an operand write stage 1160 of the instruction pipeline 1014. The operand write stage 1160 transfers the results to the write-back unit 1068a for transmission back to the originating processing element 134.

Since different cores (1010, 1020, 1030, 1040) of the AIP 144 may produce results for a same processing element 134 at approximately (or exactly) the same time, it is necessary to arbitrate access to the reply busses 148a to 148h. The write-back unit 1068a identifies the destination processing element based on the address of the results destination, or based on an appended identifier of the originating processing element appended to the return address. The write-back unit 1068a requests reply bus access (1162) from the arbiter 1048 of the originating processing element. This may be performed in a similar manner to the AIP call flag 278 used by the processing element 134. If another operand write 1160 is ready before the write-back unit 1068a has completed transmitting the previous result, or if a buffer is included and the buffer overflows, then the write-back unit 1068a may suspend the instruction pipeline 1014 until it catches up, by stalling the pipeline or by placing the micro-sequencer 1013 into a temporary sleep state (e.g., by cutting off the clock in a similar manner as used with the micro-sequencer 262 in FIG. 2).

Once the arbiter 1048 grants the write-back unit 1068a access to the reply bus 148a (e.g., using round-robin polling), the write-back unit performs an operand write back 1164, writing the execution result of the AIP function to the operand register(s) 272 of the originating processing element 134 via results bus 286. The write-back unit 1068a also may write (1165) one or more condition codes to the AIP condition code register 277 of the originating processing element (e.g., via status bus 288).

If the AIP 144 is to track (e.g., by decrementing a count) each time a result is written to the originating processing element until all of the AIP functions have been executed, then the write-back unit 1068a may determine whether the last instruction in a batch from the originating processing element has been returned (e.g., the write count for that processing element has reached zero). If so, the write-back unit 1068a may signal completion via bus line 287, setting the AIP event flag 275 of the originating processing element 134. In any case, when the write-back unit 1068a is done, it releases (1168) the reply bus, such that the arbiter 1048 will proceed to the next available result for its respective processing element.

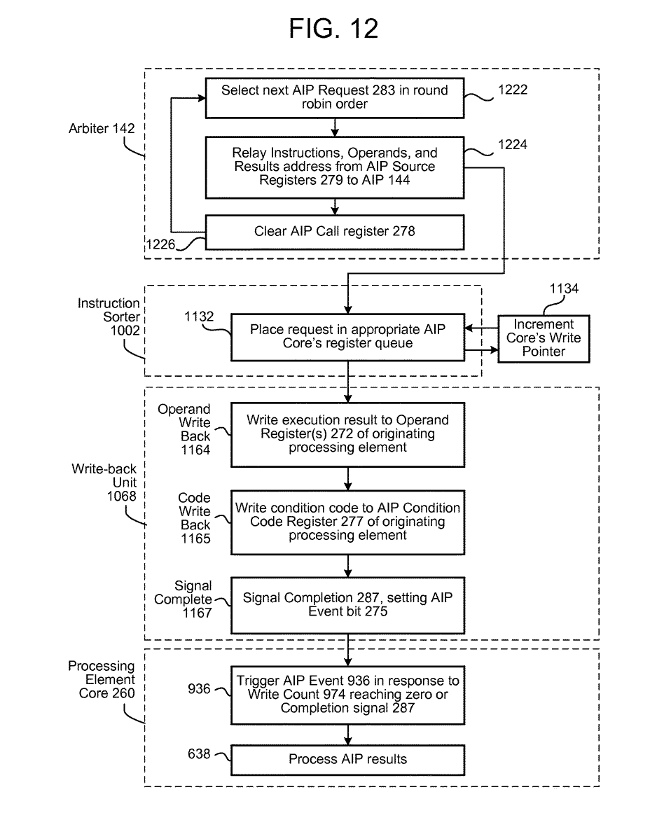

FIG. 12 is an example overview illustrating how several of the components of the chip interact to synchronize a processing element with the coprocessor. The arbiter 142 of a cluster 124 selects (1222) the next AIP request (e.g., a signal via request line 283 that an AIP call flag 278 has been set by processing element 134) in round robin order. The arbiter 142 then relays (1224) the AIP instructions, operands, and return addresses from the AIP source registers 279 of the selected processing element to the AIP 144, along with a designation of the originating processing element if not specified in the return address. The arbiter 142 then clears (1226) the AIP call register 278, and continues to poll the processing elements for AIP calls in a round-robin fashion.

The instruction sorter 1002 places (1132) the AIP processing requests received via the arbiter 142 in the appropriate AIP core's register queue. Each time data is written in to the register queue, either the instruction sorter 1002 or an increment circuit within the core itself increment's (1134) the core's write pointer, which may increment in a circular fashion.

After an instruction pipeline (1014, 1024, 1034, 1044) completes the AIP function, the write-back unit 1068 performs an operand write-back 1164, writing the execution result to the operand register(s) 272 of the originating processing element 134. A condition code write-back 1165 may also be performed, writing a condition code to the AIP condition code register 277 of the originating processing element. Either the write-back unit 1068 sends (1167) a signal completion signal via the “complete” signal line 287, setting the AIP event flag 275, or the processing element 134 does so itself when the count monitoring circuit 293 determines that the write counter 274 has reached zero.

The processing element core 260 triggers an AIP event 936 in response to the write count 974 reaching zero or the completion signal from the AIP 287. The processing element core 260 thereafter processes (638) the AIP results.

FIG. 13 is a block diagram conceptually illustrating another example of the network-on-a-chip architecture providing the shared coprocessor supporting multiple processor cores. The only difference between the architecture in FIG. 1 and FIG. 13 is the use of a signal reply bus 1348 to communicate AIP results to all of the processing elements 134a-134h. The AIP 1344 is the same as the AIP 144, except there is a single arbiter 1048 controlling access to the shared bus 1348. Using the shared bus 1348, the operand registers 272 within the cluster 124 are each assigned a unique address.

Although the examples in FIGS. 1 and 13 include a single arbiter 142 per cluster 124, and FIG. 10 includes a single arbiter 148 per reply bus 148, to speed up transactions, more than one arbiter may be used in place of the illustrated individual arbiters 142 and 1048. For example, two arbiters 142a and 142b may be substituted for arbiter 142, where arbiter 142a polls the even numbered processing elements, and arbiter 142b polls the odd numbered processing elements. Similar, each of the reply bus arbiters 1048 may be split into an arbiter that writes back to even-numbered addresses within the corresponding processing element's operand registers 272, and an arbiter that writes back the odd-numbered addresses within the corresponding processing element's operand registers 272. If even-odd reply bus arbiters are used, then referring to FIG. 1, separate even-and-odd address reply busses may be included back to each processing element 134. Likewise, referring to FIG. 13, separate even-and-odd address shared reply busses 1348 may be included within the cluster 124.

Also, if multiple AIPs 144 are shared among processing elements 134a-h in a cluster 124, an additional role that may be performed by the arbiter(s) 142 is determining which AIP 144 should receive which instruction. If the AIPs 144 are the same, this determination may be based upon load balancing, such as feedback from each arbiter 144 regarding the amount of data stored or the amount of data free in the register queues (e.g., 1012, 1022, 1032, and 1042) of its cores. Similarly, if an instruction sorter 1002 of an AIP 144 indicates that it is not ready to accept data (e.g., due to a full register queue), the arbiter(s) 142 can direct an instruction to an arbiter that is ready to accept instructions.

One way to ensure a consistent state of an AIP 144/1344 and the processing elements is to perform an asynchronous reset of components of a cluster 124. The asynchronous reset may be, for example, a Power-On-Reset (POR) or the Non-recoverable State Capture (NSC) reset. Such a reset clears the pipelines of the processing elements 134 and the AIP 144, as well as resetting and/or clearing all the flags and counters.

The above structures and examples are meant to be illustrative. They were chosen to explain the principles and application of the disclosure and are not intended to be exhaustive or to limit the disclosure. Many modifications and variations of the disclosed architecture may be apparent to those of skill in the art. The various logic circuits (e.g., gates 293, 296, 297, 298) are examples of a way the architecture could be implemented, but such logic is interchangeable with other circuits to produce a same result, as would be understood in the art. Persons having ordinary skill in the field of computers, synchronous circuit design, microprocessor design, and network architectures should recognize that components and process steps described herein may be interchangeable with other components or steps, or combinations of components or steps, and still achieve the benefits and advantages of the present disclosure. Although the architecture is designed to permit batch tasking of functions to an AIP 144, as should be clear from FIG. 7, software could be coded to send a single task as well. Moreover, it should be apparent to one skilled in the art, that the disclosure may be practiced without some or all of the specific details and steps disclosed herein.

As used in this disclosure, the term “a” or “one” may include one or more items unless specifically stated otherwise. Further, the phrase “based on” is intended to mean “based at least in part on” unless specifically stated otherwise.

What is claimed is:

1. A semiconductor chip comprising:
a first processor configured to:
issue a first plurality of instructions for processing by a coprocessor,
execute a synchronization instruction to cause the first processor to wait until first results are available from the coprocessor for all instructions of the first plurality of instructions before executing further instructions,
determine that the first results are available from the coprocessor, and
execute a first subsequent instruction using at least one of the first results; and
the coprocessor configured to:
receive and execute the first plurality of instructions, and
provide to the first results for all instructions of the first plurality of instructions.

2. The semiconductor chip of claim 1, wherein executing the synchronization instruction causes the first processor to enter a low power state.

3. The semiconductor chip of claim 1, wherein the coprocessor is configured to read the first plurality of instructions from one or more first registers of the first processor and to write the first results to one or more second registers of the first processor.

4. The semiconductor chip of claim 1, further comprising a second processor, wherein the second processor is configured to:
issue a second plurality of instructions for processing by the coprocessor,
execute a synchronization instruction to cause the second processor to wait until second results are available from the coprocessor for all instructions of the second plurality of instructions before executing further instructions,
determine that the second results are available from the coprocessor for all instructions of the second plurality of instructions, and
execute a second subsequent instruction using at least one of the second results.

5. The semiconductor chip of claim 4, further comprising an arbiter, wherein the arbiter is configured to:
poll the first processor to determine if the first processor has issued an instruction of the first plurality of instructions for the coprocessor; and
poll the second processor to determine if the second processor has issued an instruction of the second plurality of instructions for the coprocessor.

6. The semiconductor chip of claim 1, wherein the first processor is configured to issue the first plurality of instructions sequentially by writing each instruction of the first plurality of instructions to one or more registers of the first processor.

7. The semiconductor chip of claim 1, wherein issuing the first plurality of instructions comprises the first processor being configured to:
write a first instruction of the first plurality of instructions to one or more first registers of the first processor;
receive an indication that the first instruction has been read from the one or more first registers of the first processor; and
in response to receiving the indication, writing a second instruction of the first plurality of instructions to the one or more first registers.

8. The semiconductor chip of claim 7, wherein issuing the plurality of instructions comprises the first processor being further configured to:
change a bit in a second register of the first processor from a first state to a second state, in conjunction with writing the first instruction to the one or more first registers,
wherein the bit of the second register is changed from the second state to the first state after the first instruction has been read as the indication.

9. A method comprising:
storing, by a first processor, first data in one or more registers of the first processor, wherein the first data comprises a first instruction, a first source operand, and a first result address, and wherein the first result address indicates a location to store a first result of the first instruction;
indicating, by the first processor, that the first data in the one or more registers of the first processor is available for processing by a coprocessor;
receiving, by the first processor, a first indication that the first data in the one or more registers of the first processor has been read;
in response to receiving the first indication, storing, by the first processor, second data in the one or more registers of the first processor, the second data comprising a second instruction, a second source operand, and a second result address, and wherein the second result address indicates a location to store a second result of the second instruction;
indicating, by the first processor, that the second data in the one or more registers of the first processor is available for processing by the coprocessor;
receiving, by the first processor, the first result at the first result address; and
executing, by the first processor, a subsequent instruction using the first result.

10. The method of claim 9, the method further comprising:
polling, by an arbiter, the first processor to determine that the first processor is indicating that there is data in the one or more registers of the first processor available for processing by the coprocessor;
reading, by the arbiter, the first data from the one or more registers of the first processor; and
providing, by the arbiter, the first indication to the first processor.

11. The method of claim 10, wherein:
the indicating, by the first processor, that the first data in the one or more registers of the first processor is available for processing by the coprocessor comprises changing a call bit in a register of the first processor from a first state to a second state; and
the call bit changing back to the second state from the first state provides the first indication.

12. The method of claim 9, further comprising:
executing, by the first processor, a synchronization instruction to cause the first processor to wait until the first result and the second result are received from the coprocessor; and
determining, by the first processor, that the first result and the second result have been received.

13. The method of claim 12, the method further comprising:
incrementing, by the first processor, a write counter in conjunction with storing the first data in the one or more registers of the first processor;
incrementing, by the first processor, the write counter in conjunction with storing the second data in the one or more registers of the first processor;
decrementing, by the first processor, the write counter in response to receiving the first result;
receiving, by the first processor, the second result at the second result address;
decrementing, by the first processor, the write counter in response to receiving the second result; and
wherein the determining, by the first processor, that the first result and the second result have been received comprises processing a value of the write counter.

14. The method of claim 9, further comprising:
receiving, by the coprocessor, the first data;
directing, by the coprocessor, the first data to a first instruction pipeline of the coprocessor;
executing, by the first instruction pipeline of the coprocessor, the first instruction;
storing, by the coprocessor, the first result at the first result address;
receiving, by the coprocessor, the second data;
directing, by the coprocessor, the second data to a second instruction pipeline of the coprocessor;
executing, by the second instruction pipeline of the coprocessor, the second instruction; and
storing, by the coprocessor, the second result at the second result address.

15. A semiconductor chip comprising:
a plurality of processor cores comprising a first processor core and a second processor core;
a coprocessor;
an arbiter;
wherein the arbiter is configured to:
determine that the first processor core is indicating that first data stored in registers of the first processor core is available for processing by the coprocessor, wherein the first data includes a first instruction, a first operand, and a first address of a register of the first processor core,
transfer the first data to the coprocessor,
provide a first indication to the first processor core to indicate that the first data has been sent to the coprocessor,
determine that the second processor core is indicating that second data stored in registers of the second processor core is available for processing by the coprocessor, wherein the second data includes a second instruction, a second operand, and a second address of a register of the second processor core,
transfer the second data to the coprocessor, and
provide a second indication to the second processor core to indicate that the second data has been sent to the coprocessor, and
wherein the coprocessor is configured to:
execute the first instruction using the first operand,
write a first result of the execution of the first instruction to the first address,
execute the second instruction using the second operand, and
write a second result of the execution of the second instruction to the second address of the second processor core.

16. The semiconductor chip of claim 15,
wherein the arbiter is further configured to:
determine that the first processor core is indicating that third data stored in registers of the first processor core is available for processing by the coprocessor, wherein the third data includes a third instruction, a third operand, and a third address of a register of the first processor core,
transfer the third data to the coprocessor,
wherein the first processor core is configured to:
store the first data in the registers of the first processor core;
indicate that the first data is available for processing by the coprocessor;
store the third data in the registers of the first processor core after the arbiter provides the first indication;
indicate that the third data is available for processing by the coprocessor;
execute a synchronization instruction to cause the first processor to wait until both the first and third results are available from the coprocessor;
determine that the first and third results have been received; and
execute a subsequent instruction in response to determining that the first and third results have been received.

17. The semiconductor chip of claim 16, wherein the first processor core is further configured to:
increment a counter in conjunction with indicating that the first data is available for processing by the coprocessor;
increment the counter in conjunction with indicating that the third data is available for processing by the coprocessor;
decrement the counter in response to the first result being written to the first address;
decrement the counter in response to the third result being written to the third address,
wherein the first processor core is configured to determine that the first and third results have been received by processing a value of the counter.

18. The semiconductor chip of claim 17, wherein, in response to executing the synchronization instruction, the first processor core is further configured to:
wait by suspending an instruction pipeline of the first processor core in response to determining that a first value of the counter at a first time is greater than zero; and
resume operations of the instruction pipeline in response to determining that a second value of the counter at a second time is zero.

19. The semiconductor chip of claim 18, wherein the first processor core is configured to suspend the instruction pipeline by suspending an input of a clock signal to the instruction pipeline.

20. The semiconductor chip of claim 15, wherein the arbiter is configured to transfer the first data to the coprocessor as a data packet.

21. The semiconductor chip of claim 15, wherein the coprocessor comprises:
a first instruction pipeline comprising circuitry configured to execute a first type of instruction but not a second type of instruction;
a second instruction pipeline comprising circuitry configured to execute the second type of instruction but not the first type of instruction; and
an instruction sorter configured to direct received occurrences of the first type of instruction to the first instruction pipeline, and direct received occurrences of the second type of instruction to the second instruction pipeline.
